(19) United States
(12) Patent Application Publication
(10) Pub. No.: US 2025/0091807 A1
(43) Pub. Date: Mar. 20, 2025

(54) SYSTEMS AND METHODS FOR PROVIDING OBJECT PROCESSING USING MOBILE TRANSFER UNITS

(71) Applicant: Berkshire Grey Operating Company, Inc., Bedford, MA (US)

(72) Inventors: Jeffrey KITTREDGE, Lexington, MA (US); Abhishek KALURI, Beverly, MA (US); Mitchell GUILLAUME, Somerville, MA (US); Jennifer Eileen KING, Oakmont, PA (US); Kirsten WANG, Townsend, MA (US); Charles BAPTISTA, Arlington, MA (US); Kevin AHEARN, Nebo, NC (US)

(21) Appl. No.: 18/888,575

(22) Filed: Sep. 18, 2024

Related U.S. Application Data
(60) Provisional application No. 63/539,276, filed on Sep. 19, 2023.

(51) Int. Cl. B65G 1/137; G05D 1/667; G05D 105/20; G05D 107/70

(52) U.S. Cl. CPC B65G 1/1376; G05D 1/667; G05D 2105/20; G05D 2107/70

(57) ABSTRACT

An object processing system is disclosed that includes a first support structure for supporting a plurality of containers that are positioned to receive a plurality of objects, a second support structure for receiving any of the plurality of containers when each of the plurality of containers is ready to be discharged from the first support structure, and an automated mobile transfer unit for selectively transferring a selected container from the first support structure to the second support structure, said automated mobile transfer unit including a mobile chassis unit for moving the at least one automated mobile transfer unit in a first direction among the first support structure and the second support structure, and a payload transfer system supported by the mobile chassis unit and adapted to transfer a selected container of the plurality of containers from the first support structure to the second support structure.

### PRIORITY

The present application claims priority to U.S. Provisional Patent Application No. 63/539,276, filed Sep. 19, 2023, the disclosure of which is hereby incorporated by reference in its entirety.

### BACKGROUND

The present invention relates to unit sortation systems and other object processing systems for objects such as items, products, packages and other stock keeping unit (SKU) pieces as well as totes, bins and boxes containing such items, products, packages and SKUs. The present invention relates in particular to unit sortation systems that sort to a large number of containers such as bins, totes, boxes, etc.

Many conventional unit sortation systems are used for example, in package sortation and in e-commerce order fulfillment. In the case of package sortation, the unit sorter will sort packages coming into a facility from a range of locations and sort them into groupings of next station or hub or trailer truck or zip code, etc. In the case of e-commerce order fulfillment, the unit sorter will sort a mix of SKUs into individual customer orders or groups of customer orders. For example, there may be work savings in creating heterogeneous mixes of SKUs from homogenous input sources such as totes or shelves.

A unit sorter system may for example receives an item on a tray or bomb bay carrier, etc., and then it circulates the item with many other carriers carrying other items at the same time. When the carrier arrives at the destination for which the item is destined, the carrier actuates in some way. If it is a tilt tray, it tilts to empty its payload. If it is a bomb bay, the bomb bay doors open to release the item. If it is a cross-belt, the belt actuates to convey the payload off the carrier and so on. In this way sometimes over 10,000 units can be delivered to 100s of sorter destinations per hour.

The long perimeter of the unit sorter is good for the economics of the unit sorter. In the applications for the unit sorter such as package sortation and e-commerce order fulfillment, there are efficiency benefits to greater numbers of sort destinations. There is a large initial cost for the unit sorter and a small marginal cost to adding more destinations. As a result, many unit sorters have hundreds of destinations because efficiency increases.

The greater the number of destinations however, the greater the perimeter. This long perimeter spreads out the work that people need to do to process the items that go to the sort destinations. Workers who process the items that have been sorted have to walk between the many chutes or sort destinations. The workers must visit every single of the hundreds of destinations and empty the chute or tote or bag that receives the items.

There remains a need therefore, for more capable, efficient and economical unit sorter systems and other object processing systems that require sorting a large number of items to a large number of processing locations. There is further a need to reduce time expended by human personnel in waiting, walking and decision making in facilitating the operation of the system.

### SUMMARY

In accordance with an aspect, the invention provides an object processing system that includes a first support structure for supporting a plurality of containers that are positioned to receive a plurality of objects among the plurality of containers, a second support structure for receiving any of the plurality of containers from the first support structure when each of the plurality of containers is ready to be discharged from the first support structure, and an automated mobile transfer unit for selectively transferring a selected container of the plurality of containers from the first support structure to the second support structure, said automated mobile transfer unit including a mobile chassis unit for moving the at least one automated mobile transfer unit in a first direction among the first support structure and the second support structure, and a payload transfer system supported by the mobile chassis unit and adapted to transfer a selected container of the plurality of containers from the first support structure to the second support structure.

In accordance with another aspect, the invention provides a n automated mobile transfer unit for use in an object processing system. The automated mobile transfer unit includes a mobile chassis unit for moving the automated mobile transfer unit in a first direction, and a payload transfer system supported by the mobile chassis unit, wherein the payload transfer system of the automated mobile transfer unit includes a plurality of elevatable belts that may be raised and lowered with respect to the mobile chassis unit such that at least one of the plurality of elevatable belts may engage a selected container on a support structure of the object processing system when raised, and wherein each of the elevatable belts may be actuated when elevated to move the selected container thereon off of the automated mobile transfer unit.

In accordance with a further aspect, the invention provides a method of processing objects. The method includes receiving a plurality of objects at a plurality of containers on a first support structure, moving an automated mobile transfer unit in a first direction, said automated mobile transfer unit including a mobile chassis unit and a payload transfer system on the mobile chassis unit, stopping the automated mobile transfer unit under a selected container of the plurality of containers, raising the payload transfer system with respect to the mobile chassis unit to engage the selected container with a portion of the payload transfer system, and actuating the payload transfer system to move the selected bin away from the first support structure.

### BRIEF DESCRIPTION OF THE DRAWINGS

The following description may be further understood with reference to the accompanying drawings in which:

FIG. 1 shows an illustrative diagrammatic plan view of a unit sortation system in accordance with an aspect of the present invention;

FIG. 2 shows an illustrative diagrammatic end elevated view of the unit sortation system of FIG. 1;

FIG. 3 shows an illustrative diagrammatic enlarged view of a portion of a servicing area of the unit sortation system of FIG. 1;

FIGS. 4A-4D show illustrative diagrammatic views of a transfer unit of the unit sortation system of FIG. 1, showing arms engaging a completed container (FIG. 4A), showing the arms retracting to pull the container (FIG. 4B), showing the container being moved onto the conveyor of the transfer unit (FIG. 4C), showing the transfer unit pushing the container onto a conveyor (FIG. 4D);

FIGS. 5A and 5B show illustrative diagrammatic views of a transfer unit loading an empty container onto the transfer unit, showing an empty container approaching (FIG. 5A) and showing arms on the transfer unit retrieving the empty container (FIG. 5B);

FIG. 6 shows an illustrative diagrammatic view of a unit sortation system in accordance with a further aspect of the present invention that includes plural adjacent static shelves;

FIG. 7 shows an illustrative diagrammatic view of a unit sortation system in accordance with an aspect of the present invention that include a replenishment conveyor and a takeaway conveyor;

FIG. 8 shows an illustrative diagrammatic view of a unit sortation system in accordance with an aspect of the present invention that includes adjacent replenishment and takeaway conveyors;

FIGS. 9A and 9B show illustrative diagrammatic enlarged views of a transfer system in accordance with another aspect of the present invention, showing the transfer system engage a completed container (FIG. 9A) and transferring the completed container (FIG. 9B);

FIGS. 10A and 10B show illustrative diagrammatic views of the transfer system of FIGS. 9A and 9B, showing a completed container having been discharged (FIG. 10A) and showing an empty container having been placed on to a shelf (FIG. 10B);

FIGS. 11A and 11B show illustrative diagrammatic views of a transfer unit preparing to move an empty container (FIG. 11A) and moving an empty container onto a shelf (FIG. 11B);

FIGS. 12A and 12B show illustrative diagrammatic exploded end views of a transfer unit un accordance with an aspect of the present invention, showing a side view (FIG. 12A) and an end view (FIG. 12B);

FIGS. 13A and 13B show illustrative diagrammatic side views of the transfer unit of FIGS. 12A and 12B showing the support structure and the payload receiving portion not elevated (FIG. 13A) and elevated (FIG. 13B) with respect to the unit base;

FIGS. 14A and 14B show illustrative diagrammatic enlarged side views of the transfer belts of the transfer unit of FIGS. 12A and 12B with the payload receiving portion not elevated (FIG. 14A) and elevated (FIG. 14B) with respect to the unit base;

FIGS. 15A and 15B show illustrative diagrammatic enlarged side views of the elevation system of the transfer unit of FIGS. 12A and 12B with the payload receiving portion not elevated (FIG. 15A) and elevated (FIG. 15B) with respect to the unit base;

FIGS. 16A and 16B show illustrative diagrammatic enlarged views of the elevation system of the transfer unit in accordance with another aspect of the present invention that includes linear actuators with the payload receiving portion not elevated (FIG. 16A) and elevated (FIG. 16B) with respect to the unit base;

FIGS. 17A and 17B show illustrative diagrammatic enlarged views of the elevation system of the transfer unit in accordance with another aspect of the present invention that includes cam actuators with the payload receiving portion not elevated (FIG. 17A) and elevated (FIG. 17B) with respect to the unit base;

FIG. 18 shows an illustrative functional view of a container and bag fullness analysis system in accordance with an aspect of the present invention;

FIG. 19 shows an illustrative diagrammatic end view of a unit sortation system in accordance with a further aspect of the present invention that includes a central takeaway conveyor;

FIG. 20 shows an illustrative diagrammatic view of a transfer unit for use in accordance with another aspect of the invention that includes two independently movable support structures;

FIG. 21 shows an illustrative diagrammatic view of a transfer unit for use in accordance with a further aspect of the invention that includes an extending support structure; and

FIG. 22 shows an illustrative diagrammatic view of a transfer unit for use in accordance with a further aspect of the invention that includes three independently movable support structures.

The drawings are shown for illustrative purposes only.

### DETAILED DESCRIPTION

The invention in accordance with an aspect provides a system for reducing the manual work needed to service unit sorters and to centralize processing of objects such as items, packages, SKUs containers, products, etc., sorted by unit sorters. The system including automated mechatronic components may provide the following. The system may put empty containers at or underneath each chute or sort destination, may take away full containers at or underneath each chute or sort destination, may bring the containers to centralized processing stations for loading or packing into other containers, further sorting, or other processing, and may optionally automates removal of objects from specially designed containers. As used herein, containers include at least totes, bins and boxes. Applications of systems in accordance with certain aspects of the invention may include package sortation facilities that use unit sorters, e-commerce order fulfillment centers that sort batch pick orders with unit sorters, and any other systems that employ unit sorters.

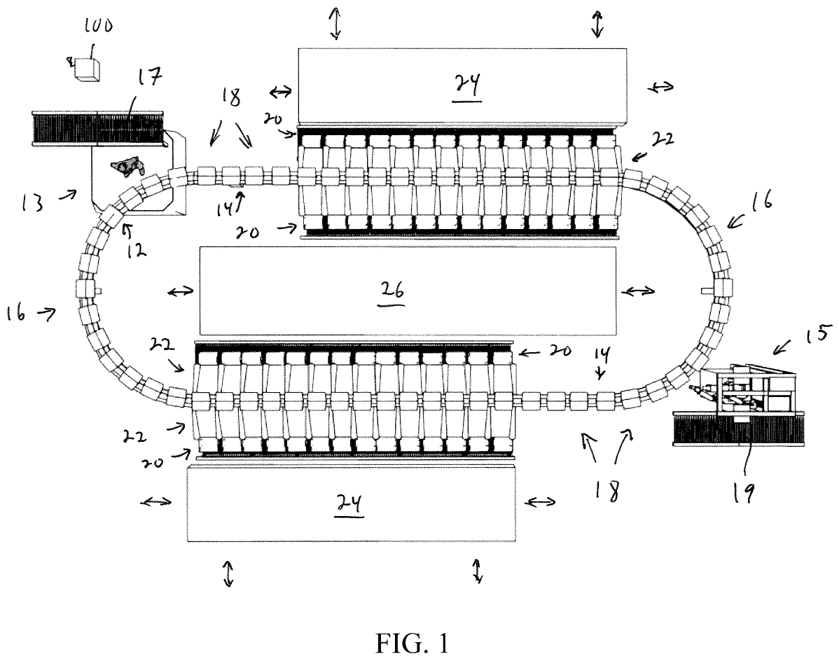

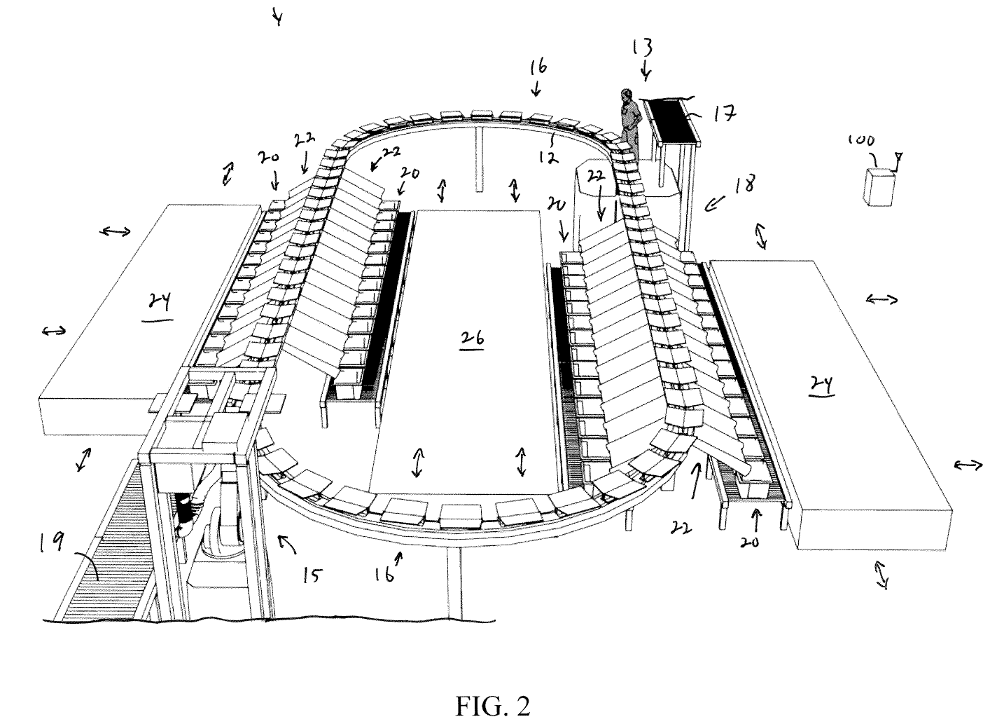

FIG. 1 shows in a top view of a unit sortation system 10 in accordance with a generalized aspect of the present invention that includes a loop conveyance system 12 that includes two straight sections 14 and two curved sections 16. The straight sections 14 each include input areas 18 at which objects such as packages, products, items, etc., may be placed onto empty carriers of the loop conveyance system 12, for example by human personnel (as shown at 13) or by using a programmable motion device (as shown at 15). Each input area may include an input conveyor for providing objects (only a portion of which is shown for clarity). The loop conveyance system may include carriers of any of tilt trays, bomb-bay units, cross belt conveyors, etc., that travel around the loop in a continuous fashion. The object is scanned prior to induction, or by a scanning system at some point along the loop. The straight sections 14 also include receiving containers 20, optionally via chutes 22 on each of the sections 14. This scanned barcode determines to which chute the object should be ejected from the carrier. The object rides along on the carrier until it arrives at chute, then the unit sorter ejects via various mechanisms such a bomb-bay, tilt tray, cross-belt, etc., The receiving containers 20 (and chutes 22) may be provided on one or both sides of the loop 12. The containers 20 when completed may be processed automatically using takeaway and replenishment systems 24 that process containers on one side thereof or takeaway and replenishment systems (e.g., 26) that process containers on two sides thereof in accordance with certain aspects of the present invention. In accordance with various aspects the takeaway and replenishment systems may include a variety of components and functionalities as discussed herein that provide container takeaway and container replenishment along a variety of directions to and from the systems 24 and 26 as generally indicated in FIGS. 1 and 2.

FIG. 2 shows an elevated end view of the system 10 showing that the chutes 22 receive objects from the loop conveyance system 12 that includes, for example, tilt trays. The chutes 22 lead to containers (e.g., totes, bins, boxes, etc.), and the containers may be provided on any of static shelves or movable conveyors. Each object that is placed onto the loop conveyance system 12 is assigned a particular container, and the system drops the object into the associated chute when the object is above the associated chute while moving along the loop conveyance system. Operation of the system including the conveyors, tilt trays, and systems 24, 26 is provided by one or more computer processing systems 100.

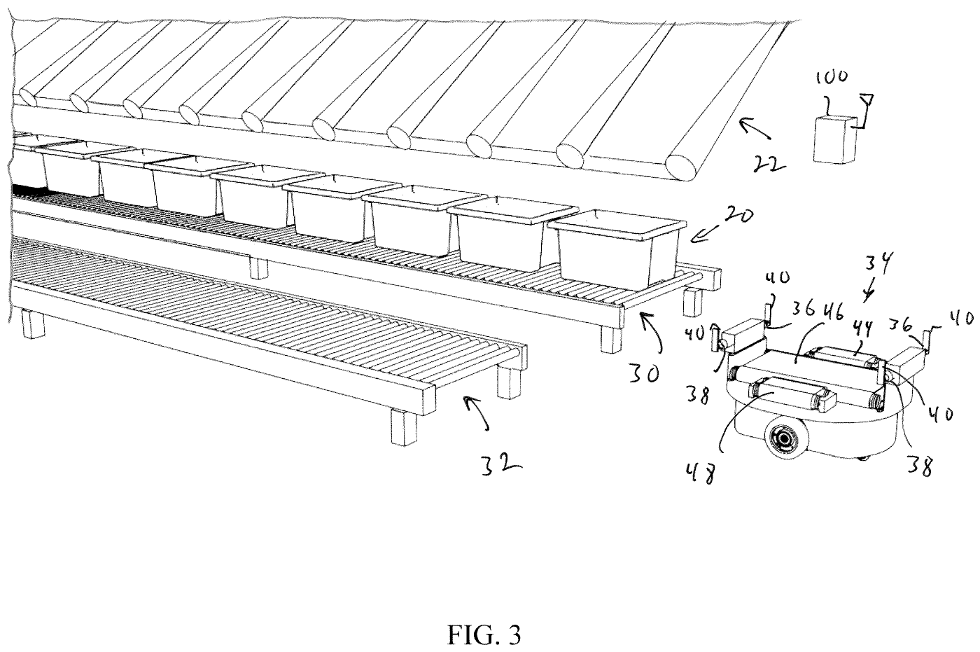

Approaches to takeaway and replenishment, for example, may provide for a static shelf and central takeaway/replenishment using a servicing automated mobile transfer unit. With reference to FIG. 3, such a system for example, may include a static shelf 30, a roller conveyor 32 and a servicing automated mobile transfer unit (such as a shuttle) 34. The static shelf may be provided with an array of containers filled by the unit sorter via chutes as shown or dropped directly into the container by a bomb bay sorter. The roller conveyor 32 takes away full containers and provides a supply of empty containers. The roller conveyor 32 may be an MDR (motor driven roller) with zero-pressure accumulation (photo eyes detect the presence of containers and stop the MDR to avoid contact between adjacent containers).

The servicing transfer unit 34 moves reciprocally along an aisle between the shelf 30 and the roller conveyor 32, and may both (i) transfer full containers from the static shelf to the roller conveyor; and (ii) transfer empty containers from the roller conveyor to the static shelf. For example, a telescoping arm with retracting latches is able to telescope into the static shelf, engage its latches, so that as it moves back toward the center of the transfer unit, it pulls the container with it across the body of the transfer unit and onto the roller conveyor. The transfer unit 34 for example may include two pairs of retractable/extendable arms 36, 38 each including actuatable latches 40.

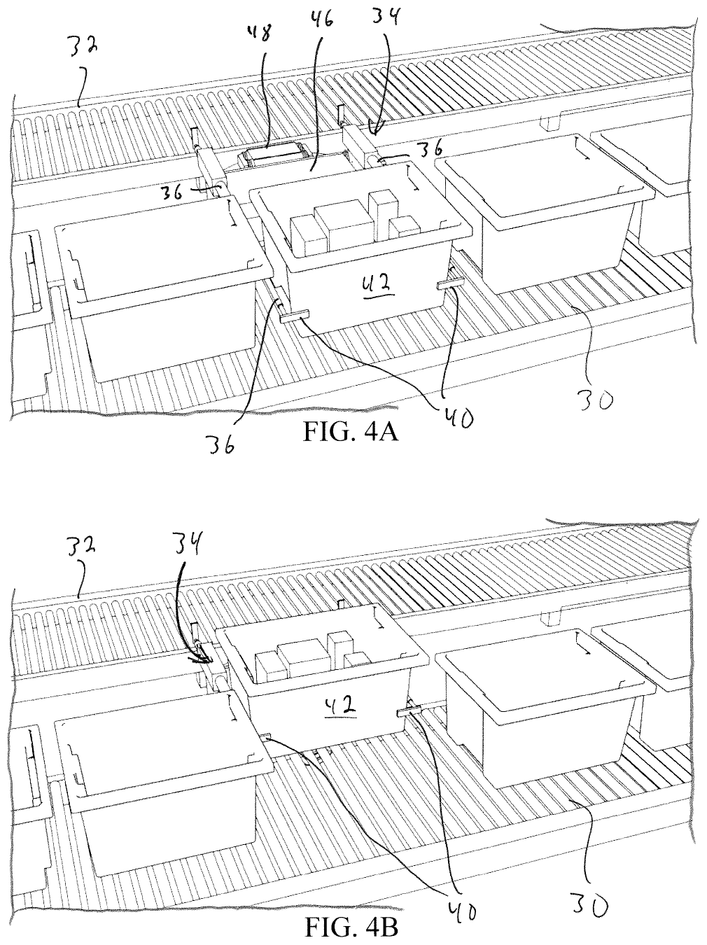

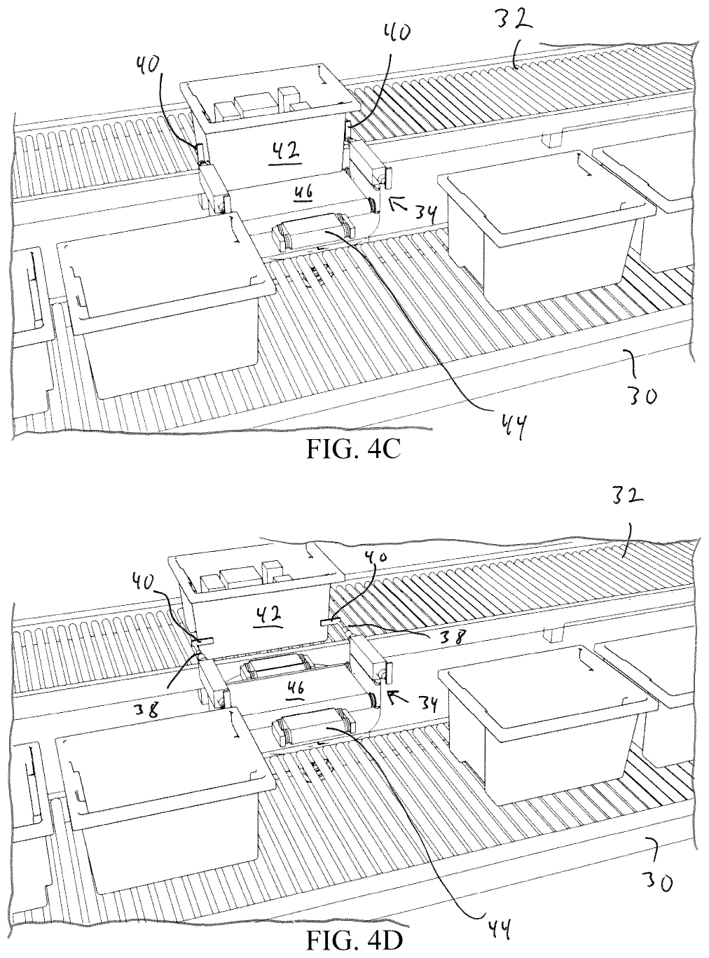

FIG. 4A shows latches 40 of arms 36 engaging a completed container 42 with the arms 36 extended and the latches 40 rotated to engage the container 42. FIG. 4B shows the arms 36 retracting pulling the container 42 toward and onto the transfer unit 34. The transfer unit 34 includes a plurality of sets of belted roller conveyors 44, 46, 48 that also facilitate moving containers onto and off of the unit 34 (as also shown in FIG. 3). Once the container 42 engages the roller 44, the belted rollers 44, 46, 48 facilitate moving the container 42 onto the unit 34. The belted conveyors 44, 46, 48 may be independently bi-directionally controllable, and may be mounted on weight sensing roller mounts. Additionally, perception units may be mounted on the automated mobile transfer unit to further or alternately provide information regarding the load on the transfer unit. FIG. 4C shows the container 42 being moved onto the conveyor 32 using the belted rollers (e.g., 46, 48), and with further reference to FIG. 4D, the latches 40 on the arms 38 may be engaged to push to the container 42 onto the conveyor 32.

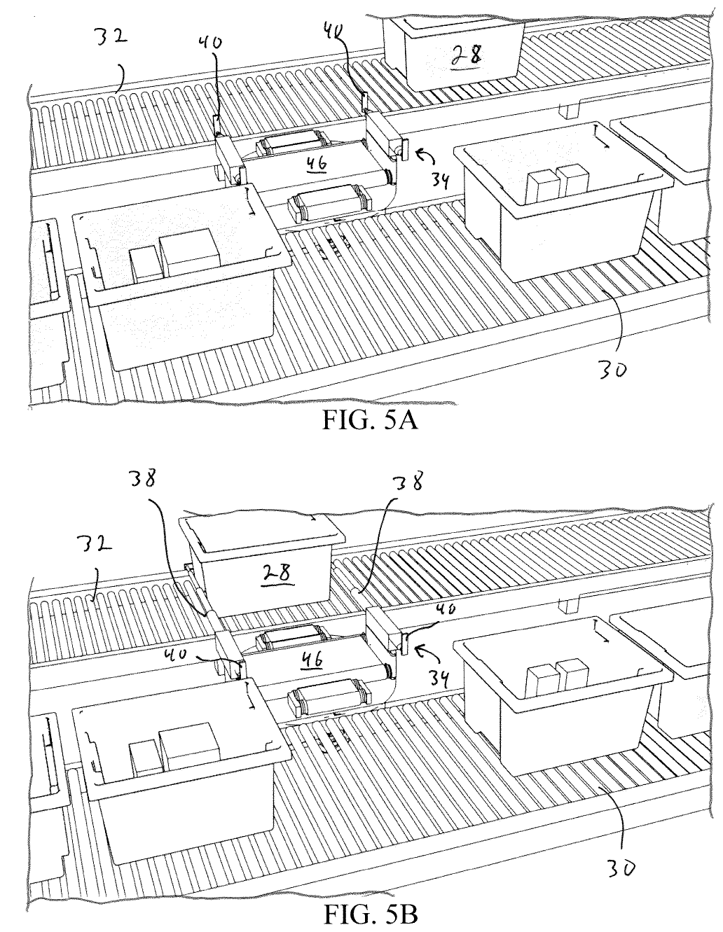

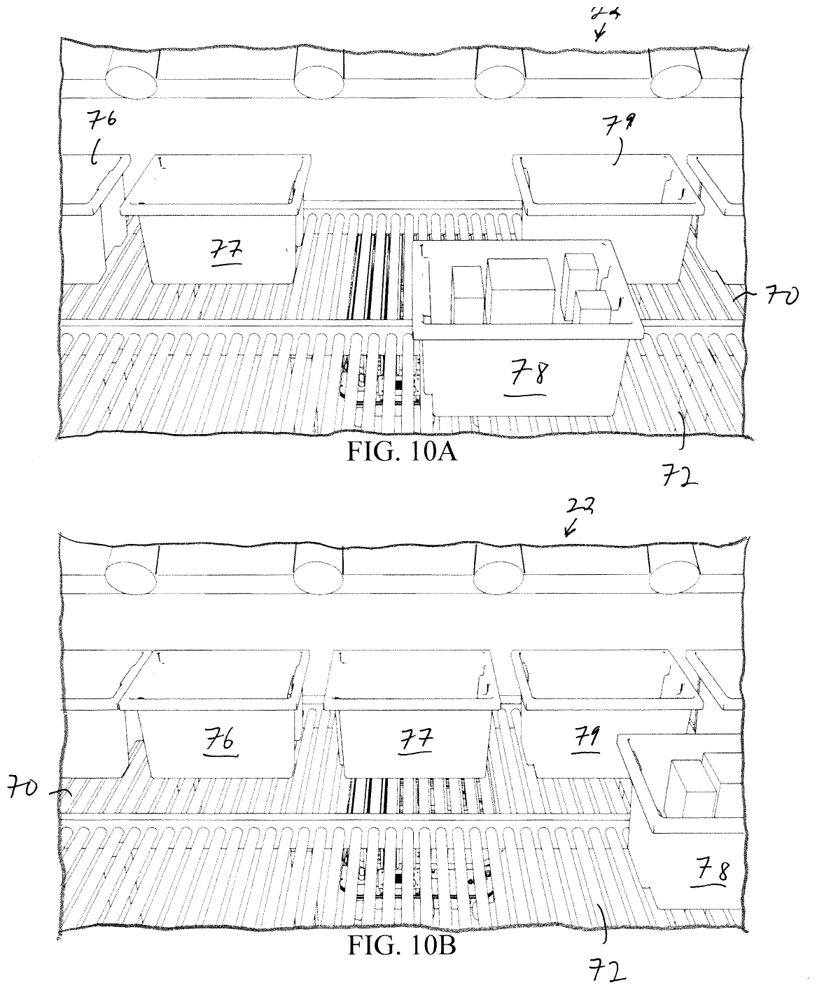

The opposite ends 38 of the same telescoping arms each also have retracting latches 40 that may be engaged when the arms 38 are extended to pull an empty container 50 onto the transfer unit 34. The empty container 50 may be pulled from the conveyor 32 all the way across the unit body to the static shelf 30. FIG. 5A shows an empty container 28 approaching along the conveyor 32, and FIG. 5B shows the empty container 28 being engaged by the transfer unit 34 using the arms 58. In the same way that the container 42 was moved from the shelf 30 the conveyor 32, the empty container 28 is engaged and moved onto the transfer unit 34 and then moved onto the shelf 30. In the system of FIGS. 3-5B, the static shelf may instead be provided as a conveyor, with new empty containers being introduced at one end, and the control system re-adjusting the location of each container as it moves to fill a spot vacated by a completed container (as discussed in more detail below with regard to FIG. 10A, 10B).

The one or more computer processing systems 100 coordinate the movements of the conveyor and automated mobile transfer unit(s), and keeps track of the states and identities of all containers on shelves and conveyors. For example, as the transfer unit is passing a full container from shelf to conveyor, it may pause the advance of preceding containers so that the full container has an empty zone on the conveyor to occupy as it is transferred by the servicing transfer unit to the conveyor. Where the conveyor 32 is a zero-accumulation conveyor, there are options for the spacing of perception unit (such as photo-eyes) on the conveyor 32. The empty containers may be provided as needed. In particular, there may be a 1:1 ratio between destination zones and shelf locations. For the transfer unit to transfer onto the conveyor the whole zone on the receiving conveyor or shelf mush be empty. For the transfer unit to transfer off of the conveyor, the desired container must be positioned in front of the zone. In all cases there may be only one container per zone. Note that there needs to be population of empty containers continually in circulation on the conveyors. Generally, the rate of replenishing containers should match the rate at which containers get kicked out.

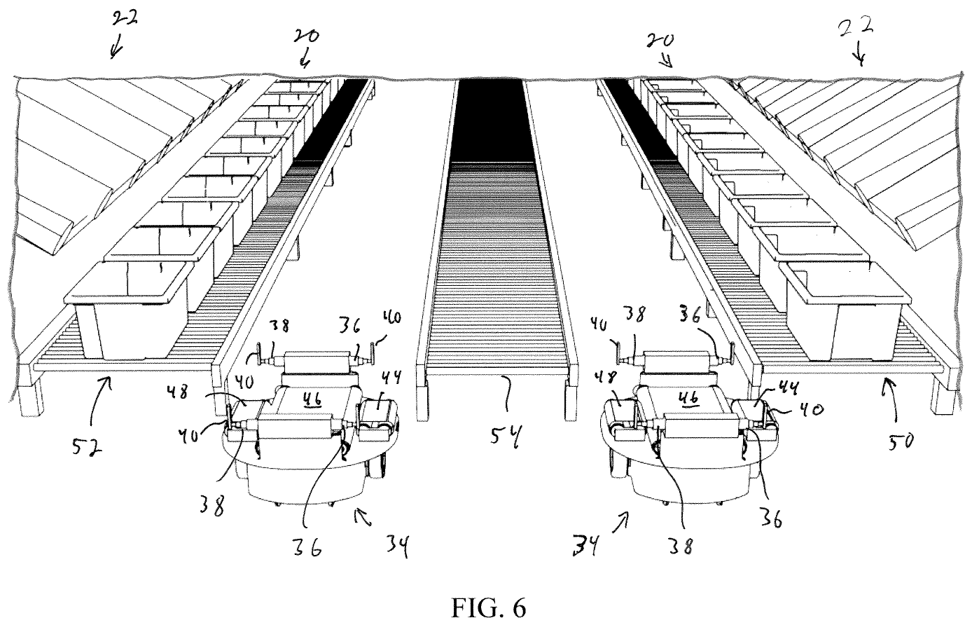

In accordance with further aspects, the system may provide that two static shelves share one replenishment/takeaway conveyor, for example in a takeaway and replenishment system 26 of FIG. 1. The system, for example, may include two static shelves 50, 52 with a replenishment/takeaway conveyor 54 between the two shelves as shown in FIG. 6. Two transfer units 34 are provided, one between each of the shelves 50, 52 and the conveyor 54. Each of the units 34 is able to travel independently along its respective aisle either between the shelf 50 and the conveyor 54 or between the shelf 52 and the conveyor 54. Each of the units 34 operates as discussed above providing empty containers to the shelves 50, 52, and removing completed containers to the takeaway and replenishment system 54. Because the system shares the conveyor 54 between the two static shelves, movement of the empty containers and completed containers must be closely controlled such that sufficient room is provided on the conveyor 54 to receive and process the containers. In accordance with further aspects, the transfer units 34 may hold onto a completed container until sufficient room exists on the conveyor 54 to transfer the container to the conveyor.

In accordance with further aspects, the takeaway and replenishment system (e.g., 24 in FIG. 1) may include separate replenishment and takeaway conveyors. Such a system may use a mechanism for storage and retrieval of containers similar to a multi-shuttle AS/RS (with the difference being that the containers receive objects from the unit sorter). In this system there are one or more replenishment conveyors, and one or more take-way conveyors, where the transfer unit positions itself to receive or donate containers, respectively. There is flexibility in regards to which side of the transfer unit the conveyors lie (may be the same side as static shelf, or opposite; may be different for each). This option may not have as high of a throughput as other systems since the transfer unit must move each container into its shelved position, without parallelization from the takeaway/replenishment conveyor in the preceding options. On the other hand, the empty containers need not be recirculated continually.

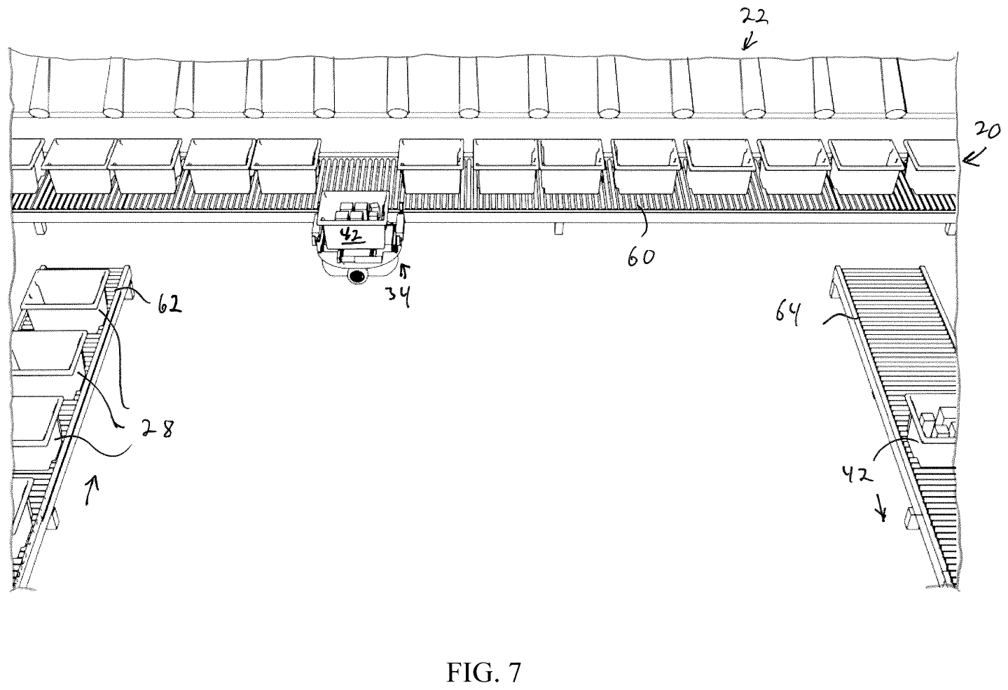

FIG. 7 for example shows a system that includes a static shelf 60, a replenishment conveyor 62 and a takeaway conveyor 64. The transfer unit 34 moves empty containers from the conveyor 62 to the shelf 60 as discussed above, and moves completed containers 42 from the shelf 60 to the takeaway conveyor 64. The transfer unit 34 operates as discussed above providing empty containers to the shelf 60 and removing completed containers to the takeaway conveyor 64. The conveyors 62, 64 may be actively or gravity biased on opposite directions (the replenishment conveyor toward the shelf 60 and the takeaway conveyor away from the shelf 60). The system provides that empty containers may always be available and that the containers taken away are moved away from the shelf without impeding the flow of empty containers toward the shelf 60. The relative spacing of the conveyors 62, 64 from each other may be based, in part, on the number of containers on the shelf between the conveyors 62, 64 as well as the anticipated processing times of the containers on the shelf between the conveyors 62, 64.

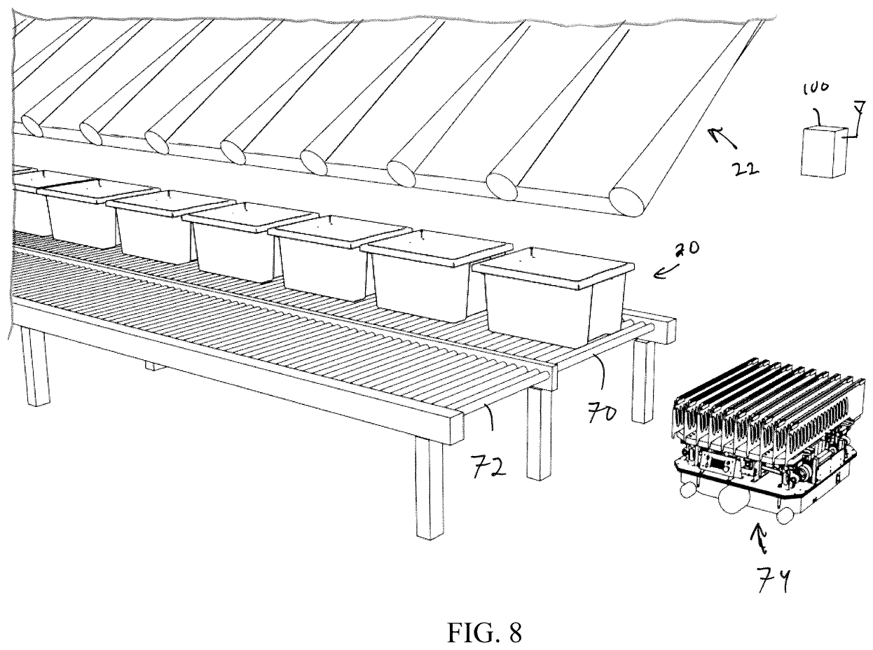

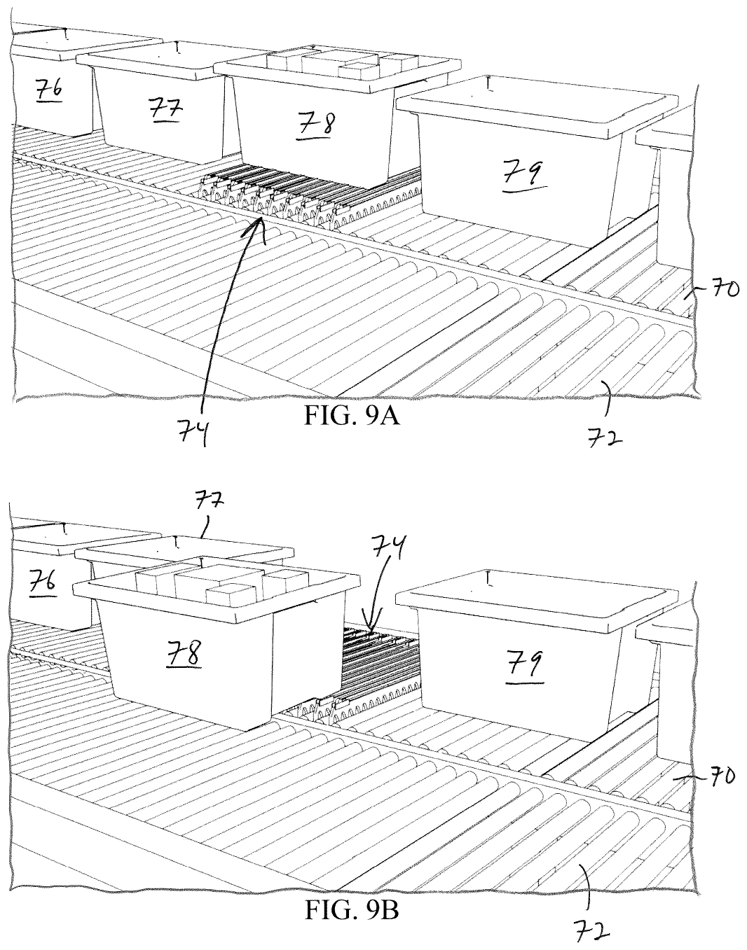

In accordance with further aspects, a transfer unit may be used that provides an alternate transfer mechanism such as a cross-direction transfer mechanism on the transfer unit itself. FIG. 8, for example shows a takeaway and replenishment system (e.g., 24) that includes chutes 22 leading to containers 20 on a static shelf 70 as well as an adjacent replenishment and takeaway conveyor 72. Automated mobile transfer units 74 move (e.g., reciprocally) along an aisle under the shelf 70 and are employed to move completed containers onto the conveyor 72. As discussed in more detail below, each transfer unit 74 includes elevatable blades the extend up between tines (or static rollers) of the slotted shelf 70 to lift a completed container (e.g., 78 as shown in FIG. 9A), and narrow belted conveyors on the top of each blade that transfer the completed container from the shelf to the conveyor (as shown in FIG. 9B).

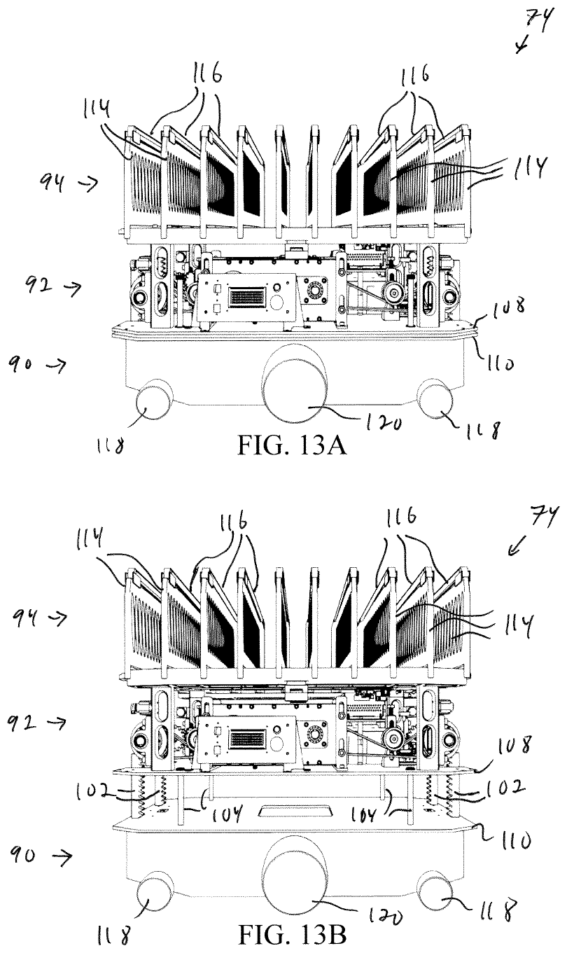

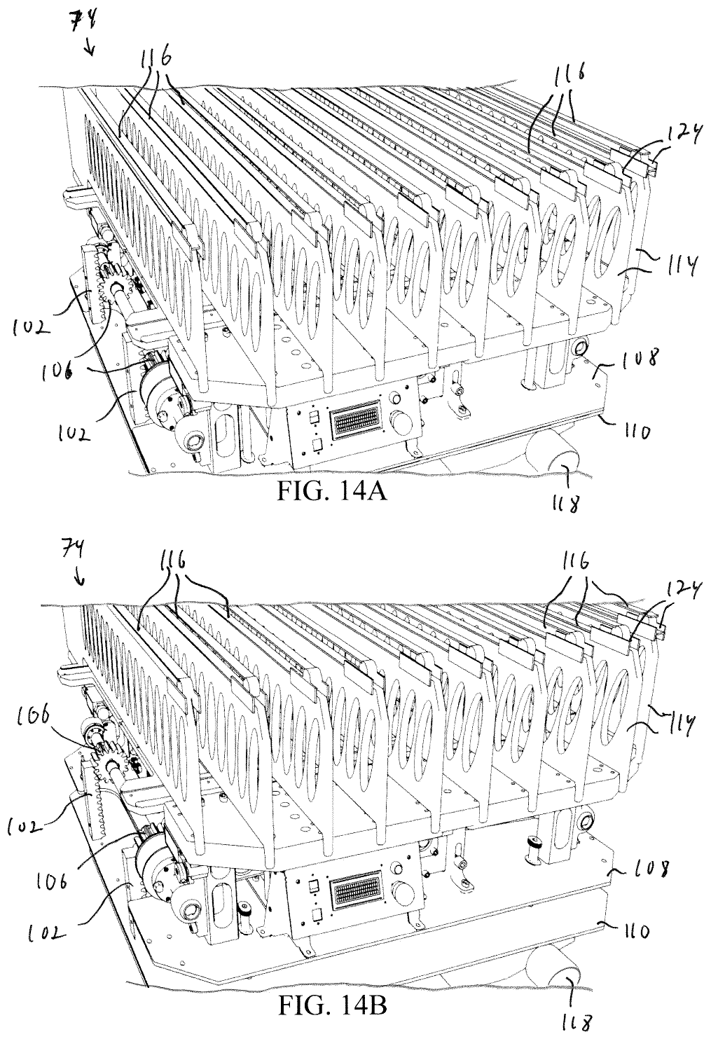

The system is similar to the systems described above in that there is a transfer unit for transferring containers between static shelving and a roller conveyor. The conveyor serves the same function: to takeaway full containers and to supply empty containers. The primary difference is in the mechanism of transfer. In this system, the static shelving is slotted so that the transfer unit may transfer containers on or off the slotted shelf by means of a narrow conveyor belt mounted on retractable blades (as further shown in FIGS. 13A, 13B). The retractable blades rise in between the spaces between the rollers on the conveyor.

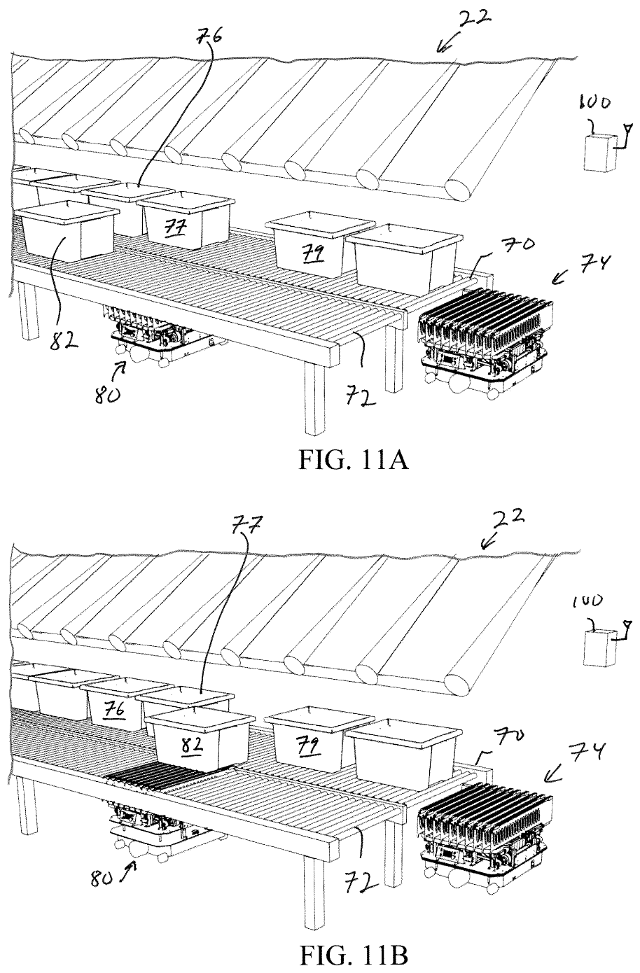

With reference again to FIG. 9A, the completed container 78 is selected from among the plurality of containers (e.g., 76, 77, 79) on the shelf 70. The completed container 78 is transferred to the conveyor 72 by the narrow-belted conveyors on the elevated blades of the transfer unit 74. With reference to FIG. 10A the conveyor 72 may be actively moving (and as further discussed herein its movement may be intermittently controlled) to move the completed container 78 toward an output end of the conveyor 72. The system may either replace a new empty container into the location on the shelf 70 remaining following removal of the container 78 (as discussed below with reference to FIGS. 11A, 11B), or the shelf 70 may be provided as a roller conveyor in which the rollers may be individually (or by section such as a section associated with an individual container) actuatable to move containers formerly adjacent the removed container in a direction to fill the void left by the removed container 78. FIG. 10A shows the removed container 78 being moved along the conveyor 78 following transfer to the conveyor 78, leaving a void on the shelf 70 where the container 78 had been. FIG. 10B shows the adjacent container 77 (which had formerly been adjacent the container 78) having been brought into the space vacated by the container 78 such that it is now adjacent 79 (which had also been adjacent the container 78). The containers down the line of direction of container 77 (e.g., container 76, etc.) are all brought in the same direction as container 77 one location. The system will record the change in the container locations and adjust the assignment locations for objects accordingly. Empty containers may then be replenished (e.g., by human personnel or automated system) at the end of the shelf in the direction from which the moved containers had moved. In accordance with various aspects, the containers may be moved until touching each other where the distal end of the line of containers is maintained at a fixed location. Conversely, perception systems may be employed together with separately actuatable rollers to position containers at specific known locations. The perception system may include any of photo-detectors, cameras, 2D scanners and 3D scanners mounted on or near the shelf, as well as weight sensing conveyor roller mounts, and wireless position tracking systems such as Bluetooth, echo-location and GPS systems.

In accordance with further aspects (and as noted above) the empty location that remains after the completed container 78 is removed may be individually filled using, for example, a further automated mobile transfer unit 80 that moves (e.g., reciprocally) under the conveyor 72 as shown in FIGS. 11A and 11B. FIG. 11A shows an empty container 82 being moved along the conveyor 72, and FIG. 11B shows the unit 80 being activated as discussed herein to transfer the empty container 82 from the conveyor 72 to the shelf 70. Any of the automated mobile transfer units 34, 74, 80, 130, 160, 190 disclosed herein may also be moved in directions other than the associated reciprocating directions by activating the primary central drive wheels differently (e.g., in speed or opposing directions) to provide that a single transfer unit may be moved from under one of a shelf or conveyor to the other of the shelf or conveyor (thus avoiding using two transfer units). Such two-dimensional movement of the transfer units however, requires further safeguards regarding the precise positioning of each transfer unit under a shelf or conveyor to ensure that the blades precisely rise between upper rollers, tines, slots, etc.

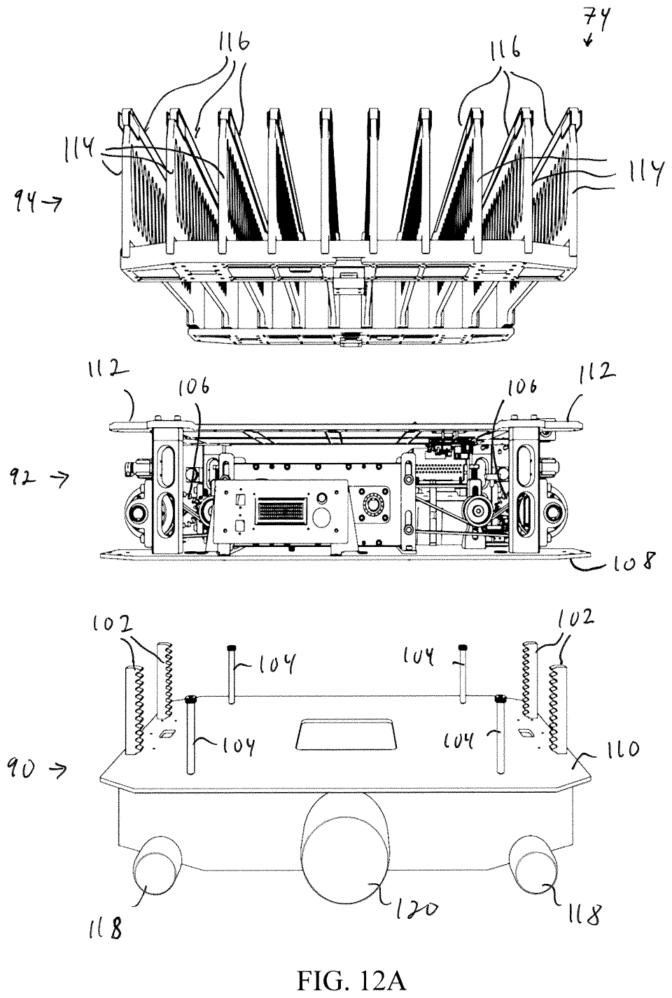

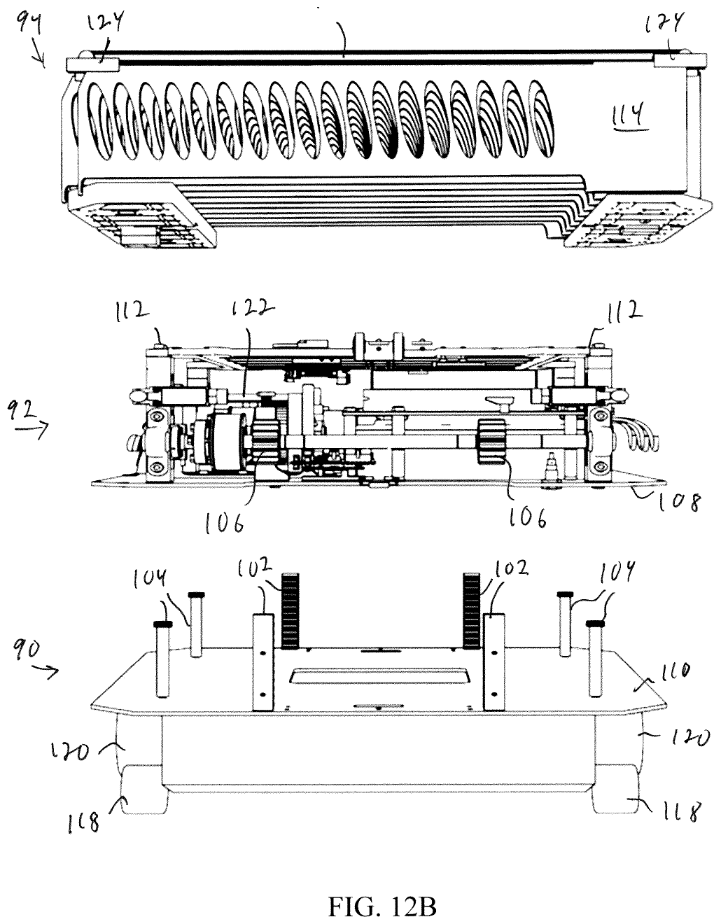

FIG. 12A shows an exploded side view of the transfer unit 74 and FIG. 12B shows an exploded end view of the transfer unit 74. The transfer unit 74 includes a unit base 90, a support structure 92, and a payload receiving portion 94. The unit base 90 includes a pair of central drive wheels 120 as well as two sets of leveling wheels 118. The unit base 90 also includes two pairs of gear racks 102 that engage with pinion gear 106 on the support structure 92. The support structure 92 includes a drive system 122 that powers the pinion gears 106 to rotate on their respective axles, and rotation of the pinion gears 106 causes the support structure 92 to rise with respect to the unit base 90. The unit base 90 also includes capped slide rods 104 that limit vertical movement of the support structure 92 away from the unit base 90, and in particular limit movement of the floor 108 of the support structure 92 away from the top surface 110 of the unit base 90. Reversing the rotation of the pinion gears 106 by the drive system 122 brings the support structure down toward the unit base.

The support structure 92 supports the payload receiving portion 94, which is mounted on a top surface 112 of the support structure 92. The payload receiving portion 94 includes blades 114 on which are mounted narrow bi-directionally actuatable belts 116. FIG. 12A shows end views of the blades 114 with belts, and FIG. 12B shows a side view of a blade 114 with a belt 116. The belts 116 may be actuatable by one or more belt drive systems 124 as show in FIG. 12B. The transfer unit 74 is therefore able to move reciprocally (or in two-dimensions as discussed above), and when the blades 114 are elevated, the narrow belts may be actuated in either of two directions to move a payload thereon off of the unit 74.

In particular, FIG. 13A shows the support structure 92 and payload receiving portion 94 in a lowered position such that the top surface 110 of the unit base 90 is in contact with the floor 108 of the support structure 92. FIG. 13B shows the support structure 92 and payload receiving portion 94 in an elevated position such that the top surface 110 of the unit base 90 is separated from the floor 108 of the support structure 92 by a distance of a length of the gear racks 102. FIG. 14A shows an enlarged view of a pair of pinion gears 106 engaging a pair of gear racks 102, and FIG. 14B shows an enlarged view of the pair of pinion gears 106 having climbed the gear racks 102. FIGS. 14A and 14B also show enlarged views of the blades 114 with narrow belted conveyors 116 thereon, which as bidirectionally powered by drive systems 124.

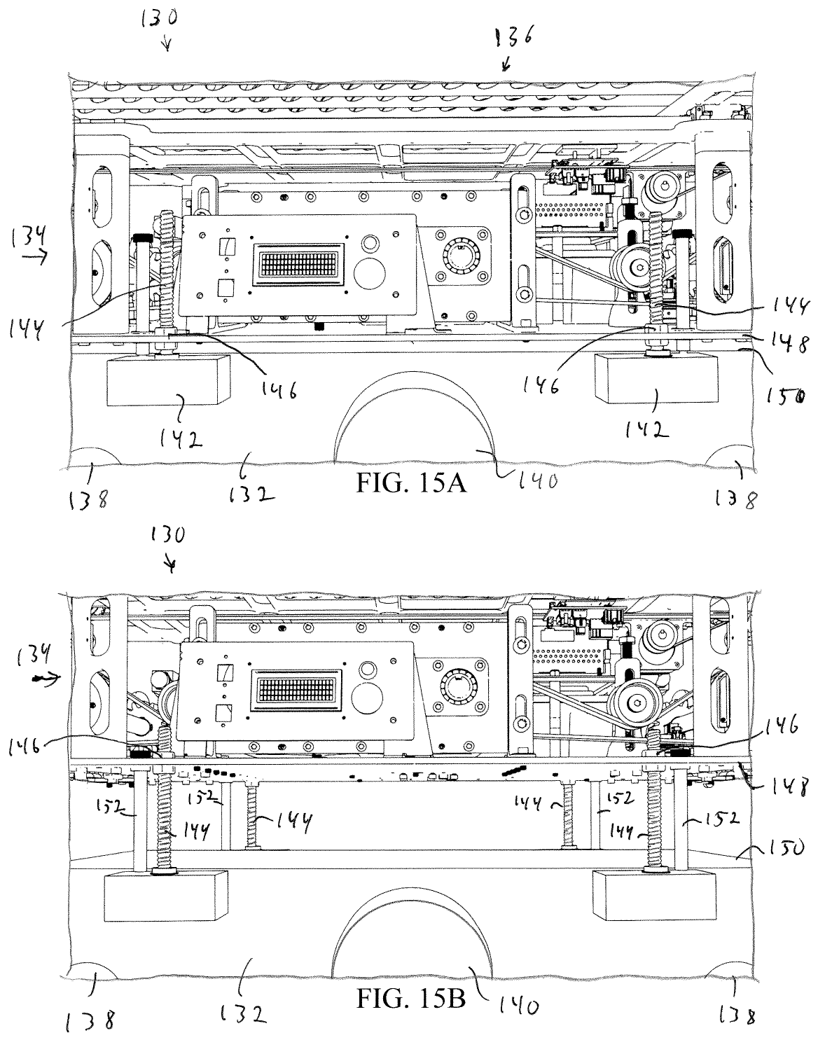

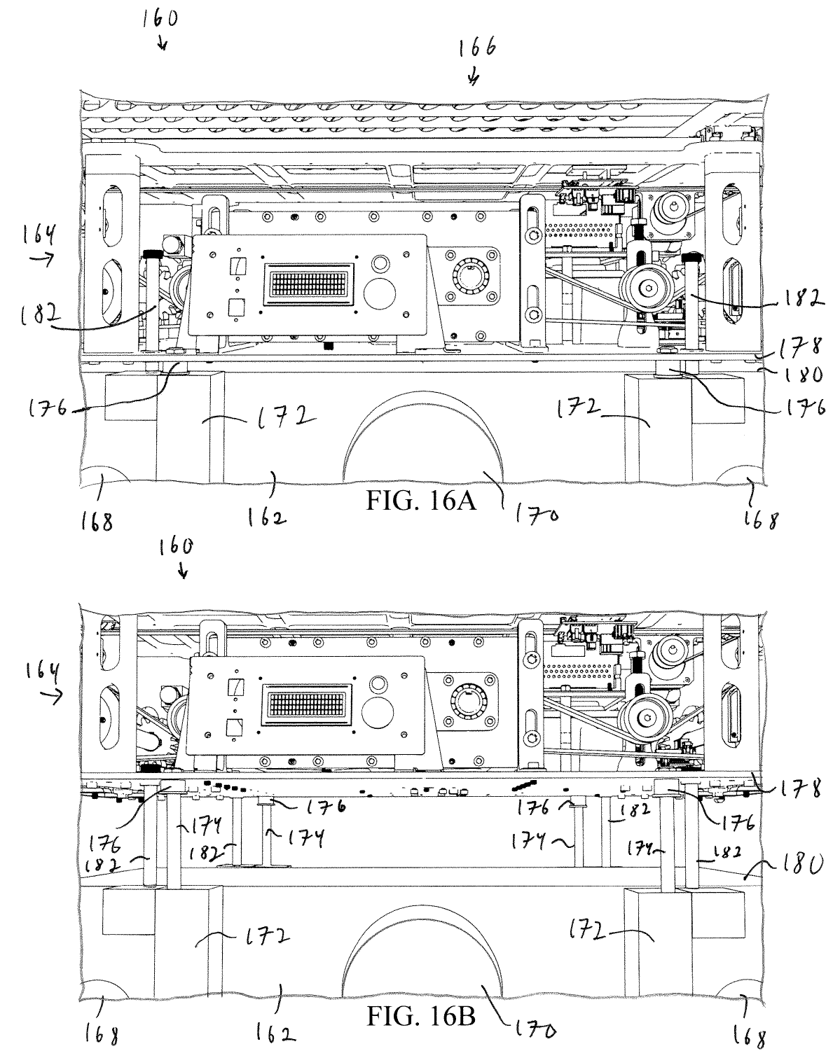

In accordance with various other aspects of the invention, the elevation of the support structure 92 (and the payload receiving portion 94) with respect to the unit base 90 may be accomplished by a variety of alternative techniques, including for example, screw drives, linear actuators, and mechanical cam systems, etc. FIGS. 15A and 15B show an enlarged view of an automated mobile transfer unit 130 that includes a unit base 132, a support structure 134 and a payload receiving portion 136. The unit base 132 includes a pair of central drive wheels 140 as well as two pairs of leveling wheels 138 as discussed above, as well as a screw drive system that includes four screw drive actuators 142 that each cause a screw 144 to rotate. As each screw 144 rotates, a slide nut 146 in each screw 144 that is also mounted to the floor 148 of the support structure 134 is urged from a lower position (as shown in FIG. 15A) to an upper position (as shown in FIG. 15B). This causes the floor 148 of the support structure 134 to move (upwardly) away from the top surface 150 of the unit base 132. Again, capped slide rods 152 limit the upward movement of the support structure 134 away from the unit base 132. In this way, the support structure 134 and payload receiving portion 136 (with the blades and narrow belted conveyors as discussed above) may be elevated and lowered as required.

In accordance with various still other aspects of the invention, FIGS. 16A and 16B show an enlarged view of an automated mobile transfer unit 160 that includes a unit base 162, a support structure 164 and a payload receiving portion 166. The unit base 162 includes a pair of central drive wheels 170 as well as two pairs of leveling wheels 168 as discussed above, as well as a linear actuator system that includes four linear actuators 172 that each cause a rod 144 to move either upward or downward. As each rod 174 is elevated, a fixed nut 176 on each rod 174 that is also mounted to the floor 178 of the support structure 164 is urged from a lower position (as shown in FIG. 16A) to an upper position (as shown in FIG. 16B). This causes the floor 178 of the support structure 164 to move (upwardly) away from the top surface 180 of the unit base 162. Again, capped slide rods 182 limit the upward movement of the support structure 164 away from the unit base 162. In this way, the support structure 164 and payload receiving portion 166 (with the blades and narrow belted conveyors as discussed above) may be elevated and lowered as required.

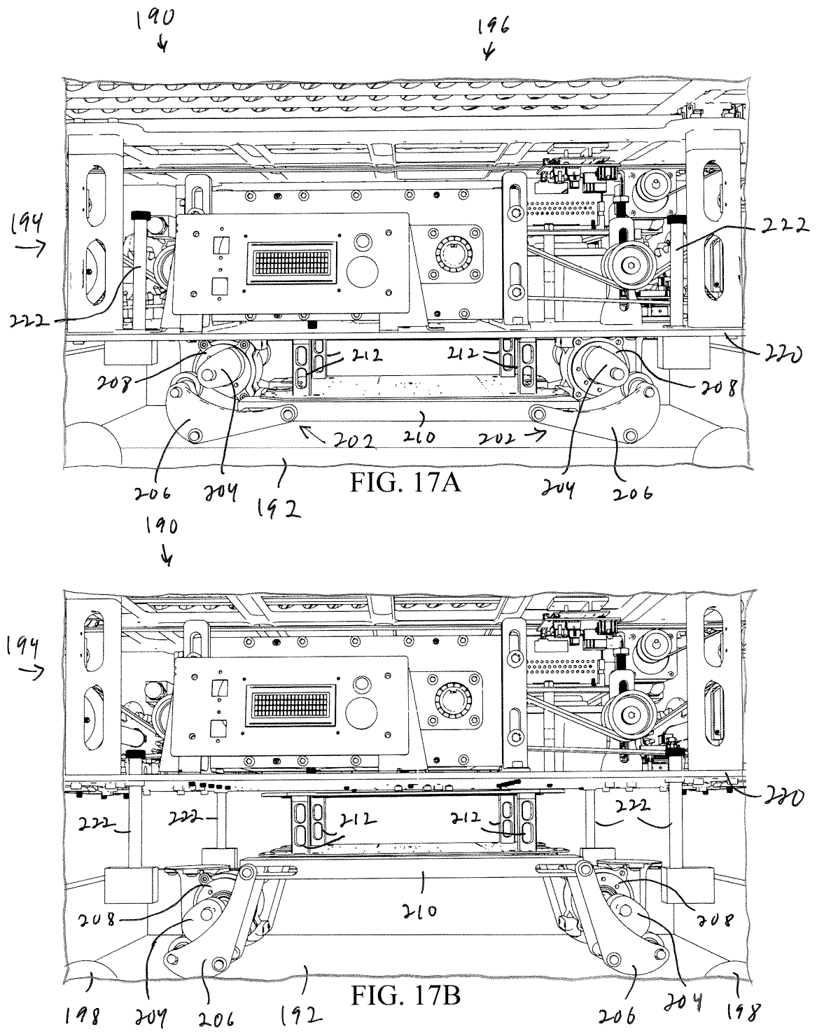

In accordance with yet a further aspect of the invention, FIGS. 17A and 17B show an enlarged view of an automated mobile transfer unit 190 that includes a unit base 192, a support structure 194 and a payload receiving portion 196. The unit base 192 includes a pair of central drive wheels 1 (not shown as a side wall portion of the unit base 192 is removed for clarity) as well as two pairs of leveling wheels 198 as discussed above. The transfer unit 190 also includes mechanical cam systems 202, each of which includes cams 204 that are urged against followers attached to rockers 206. The cams 204 are rotated by drive systems 208. The ends of the rockers 206 are attached to cross beams 210 that support a sub-support structure 212 that in turn supports the support structure 194. FIG. 17A shows the cams 204 rotated such that the rockers are positioned to permit the cross beams 210, sub-support structure 212 and support structure 194 to remain in a lowered position. FIG. 17B shows the cams 204 rotated such that the rockers urge the cross beams 210 upward, which lifts the sub-support structure 212 and the support structure 194. Using the motors 208, the cams are used to lift and lower the support structure 194 (as well as the blades and narrow belted conveyors). Again, capped slide rods 222 limit the upward movement of the support structure 194 away from the unit base 192. In this way, the support structure 194 and payload receiving portion 196 (with the blades and narrow belted conveyors as discussed above) may be elevated and lowered as required.

As discussed above with reference to FIGS. 10A and 10B, as an alternative to replenishment by the transfer unit, another option is to replenish empty containers by having the shelf be provided as a biasing conveyor. Then, instead of replenishing empty containers via a transfer unit, empty containers are replenished via conveyor (e.g., a destination conveyor). The transfer unit remains, however, to kick full containers out onto a takeaway conveyor. Once a container is kicked out, the containers upstream on the destination conveyor move forward to fill the spot of the now empty position (they accumulate). This opens up a position at the very beginning of the destination conveyor for an empty container to move in. This has the advantage that empty containers need not circulate on a conveyor as they do in other systems and eliminates the need for the transfer unit to service empty containers at all.

Note that during the accumulation step, some or all of the containers may be in motion on the destination conveyor. During this time, the unit sorter must be controlled so as to not deliver to those destination containers known to be in motion (otherwise the sorted object would fall through the conveyor). If the unit sorter has an object for a container in motion, then the unit sorter would re-circulate the object, i.e., send it around the unit sorter again; this has a detrimental effect on the performance of the unit sorter. After accumulation the correspondence between destination codes and positions on the unit sorter is changed, since the physical tots have shifted. A new destination map is provided to the unit sorter.

There are options for accumulation that are determined by the number of zones on the conveyor. One option employs zero-pressure accumulation, in which case there is a zone for each unit sorter position so that none of the containers touch each other. Another option employs minimal-pressure accumulation, in which there is only one conveyor zone resulting in the containers gently touching (such that there is no more than a maximum pressure exerted on each container). There are pros and cons of each. A zero-pressure accumulation conveyor requires a photo-eye or zone at each container location. When the photo-eye is closed, i.e., blocked, the section of destination conveyor under the corresponding container does not advance. So, the photo-eyes keep the containers from touching. container positions are in 1:1 correspondence with conveyor zones. This gives the system controller the ability to control which containers are in motion. If, for instance, the system knows that an object is soon to be sorted into a to-be-accumulated container, the system can wait to accumulate that container until completion of the sort by the unit sorter.

Minimal pressure accumulation, on the other hand, does not a require photo-eye for each unit sorter position. This may reduce expense of the system. However, during accumulation, in the worst case all the remaining containers shift forward. This would prevent the unit sorter from sorting to any of those destinations. Furthermore, in this case the distance between the containers becomes very important. The system is blind to where each container is, it only knows a containers actual position along the conveyor by multiplying the width of the container by the container position. Therefore, if the containers are boxes, for instance, then the boxes widths need to be tightly controlled, or, e.g., put in trays as may be the case with other shuttle sorting systems. To balance these two extremes there are also choices in between where there may be multiple zones, but not as many zones as container positions.

In accordance with further aspects, systems of various of the disclosed and presented systems of the invention may include dynamic destination mapping and scheduling. In particular, for package sortation applications, the destinations on a conventional unit sorter are assigned statically. In any of the automated approaches, due to the fact the destinations no longer have meaning to people pulling from them, the destinations may be assigned dynamically.

For e-commerce applications, where the unit sorter sorts mixed objects into collections of one or more orders, this allows containers with high priority orders, e.g., with expedited fulfillment or shipping, to be kicked out automatically so as to prioritize them as soon as all the objects in the order are received from the unit sorter into the order container.

For package sortation, each destination might be a zip code and/or combination of priority, for instance. In some instances where there are manual takeaway operations, it may be necessary to pull a set of destinations/zip codes at a certain time to make sure the packages are ready for the next truck out for that set of zip codes; there might for example, be a cut time. In any of the automated approaches, the takeaway of the containers to meet these cut times may be performed automatically according to a schedule.

Additionally, for package sortation, dynamic allocating sort points (at the end of unit sorter chutes) to destinations allows controls and software to modulate the number of chutes assigned to a particular destination in real time and based on a host of reasons. For package sortation more destinations could be added live or up-front if a particular destination/city has a higher-than-normal amount packages to receive during a given sort. Static control algorithms or machine learning-based control algorithms could be employed to assign chutes to destinations based on volume. Dynamic chute allocation also allows re-assignment to occur in real time for redundancy purposes if a particular portion of the machine were to stop; this enables the entire machine to keep running. Dynamic allocation also allows on the fly editing to further break a destination into a sub-group. For example, if Boston, MA is receiving twice the normal packages for a particular sort, the system may assign two destinations instead of one and divide the two new destinations as, for example, north of Boston and south of Boston which alleviates the downstream sorting need.

In the case of dynamic allocation, to ensure accuracy of the entire sortation system, in the cases where the shuttle places, pushes or conveys a container, the container's identity is tracked with a barcode, and the shuttle may have a barcode scanner to scan during place, push or conveyance. This prevents mismatch between virtual state and actual state of containers.

In accordance with further aspects, certain systems of the invention disclosed and described herein may support hybrid takeaway systems. For example, in some of the systems, a container may be deemed to be complete or full by a manual operator, who may manipulate the container, e.g., by pushing the container onto takeaway conveyor in case certain of the systems disclosed and described herein.

The removal and discharging of the containers may also be accomplished in a variety of ways in systems in accordance with various aspects of the present invention. For example, may also involve discharging objects from the containers. This may be particularly important for package sortation applications where the eventual destination for the objects in the container is a plastic bag (or Forever mail bag, e.g.) that may be packed onto an outgoing trailer of the facility. Further, a number of packages in a container could be heavy and hard for a person to tip and dump the container; in this case they may have to transfer packages by hand. In accordance with further aspects, the system disclosed and described herein may take packages or objects in the containers and automatically transfer the objects from the container to a container such as a bag.

One way to achieve this, for example, is to use containers with a hinged bottom. The container is constructed so that its bottom and the packages within fall down while the container walls are supported. Once the packages drop, they can be dropped through directly to a waiting empty bag. Then, a worker removes the now full bag, a label is printed out for the worker to apply to the bag that corresponds to the container's identity. The worker removes the bag and replaces with a new empty bag. Furthermore, the bagging, tagging and removal may all be done automatically. In some applications, not all containers will dump at every dumping station. With the mechanism described above dumping can be controlled so that a container can pass the dumping station and dump or not dump. If a container is desired to empty at a particular location, actuated rails retract and allow bottom flap to swing open. If the rails do not retract the container passes the station without dumping.

The labor to process the output (bagging or boxing) is somewhat proportional to the number of bags/boxes used, up to an ergonomic limit. Typically, the less bags/boxes being processed the less labor required. Usually, it behooves the system operator fill bags/boxes as much as possible without exceeding an ergonomic limit. Along these lines typically the largest bag/box which does not result in ergonomic problems results in the lowest cost operation. Under full bags/boxes results in shipping air from the sorting site which is costly. So, once a container under the sorter is considered full, a bag/box process that can right size the bag/box to just hold the contents of the container is the most economical option. The proposed system may monitor the actual contents of and output container for the objects, and may advise a manual or robotic bagging/boxing operation that is the right size outbound bag/box. If the sorter of which the automated take away and bagging/boxing is being done in connection with is for sorting sealed packages being shipped from A to B; then more optimizations can be applied. The output of a package sorter used in a logistics operation often must meet truck times or plane times. An automated take away system can automatically discharge destinations from the sorter to meet their truck time or plane time.

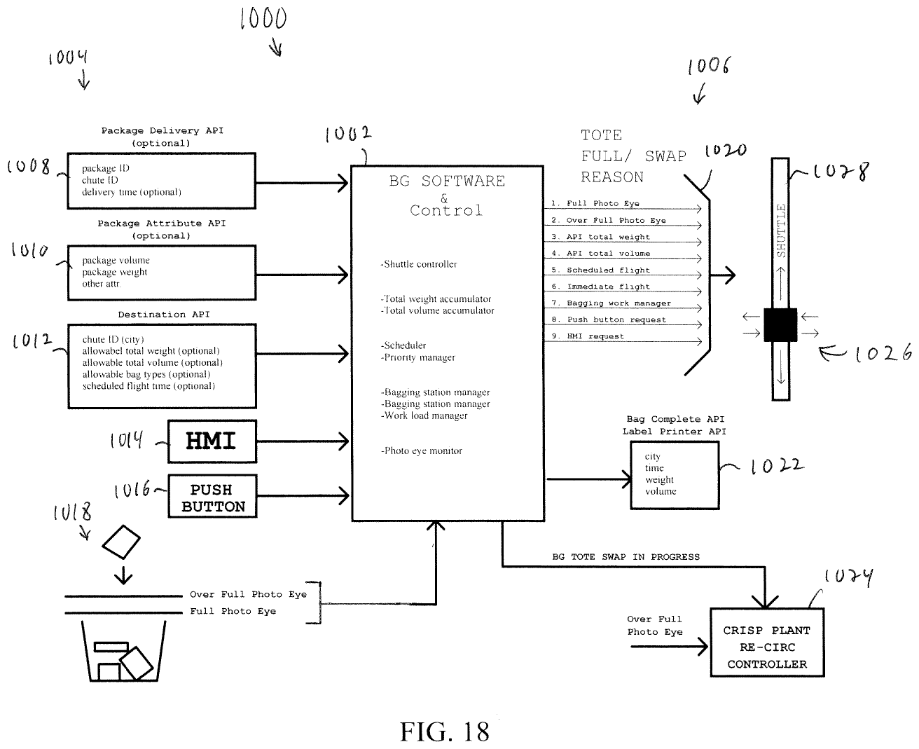

FIG. 18 for example, shows a functional diagram of a container and bag fullness analysis system 1000 for use in accordance with an aspect of the invention (e.g., in any of the object processing systems discussed herein). The analysis system 1000 determines when a container is complete enough to be traded for an empty container, and includes a software and control system 1002 (e.g., that may reside in the one or more computer processing systems 100, 200). The system 1000 receives input parameters as shown at 1004 and provides completeness determinations as shown at 1006 based on any of a variety of reasons as discussed below. The input parameters include package delivery information shown at 1008, package attribute information shown at 1010, destination information shown at 10212, human machine interface information shown at 1014, push button information shown at 1016, and full and over-full detection information as shown at 1018.

The package (object) delivery information (e.g., provided via an application programming interface, API), includes package ID, chute ID and delivery time as shown at 1008. The package attribute information (e.g., provided via API) includes package volume, package weight, package size and other attributes as shown at 1010. The destination information (e.g., provided via API) includes chute ID (city, allowable total weight, allowable total volume, allowable bag types, and scheduled leaving times (e.g., flight times). The human machine interface may provide additional observable information regarding the package as shown at 1014, and the push button information may include pre-programmed select information that may be entered very quickly as shown at 1016. The full and over-full detection information as shown at 1018 may be provided by one or more sensor systems discussed above with reference to the detector pairs.

The software and control system 1002 receives the above input information and processes the data to control the transfer unit, monitor total weight accumulated, monitor total volume accumulated, monitor any changes in the schedule and/or priority, and monitor the full and over-full detection information. The control system 1002 also communicates with boxing and bagging station managers as well as work-load managers. The system, for example, may not simply rely on one or two points of information (e.g., a full or over-full sensor signal), but may consider total weight or total volume. If the total weight and/or total volume are far too low, the system will not consider the container to be completed. On the other hand, if a scheduled leaving time (e.g., flight) or immediate leaving time is approaching, the system may consider the container to be completed not-withstanding other data indicating otherwise. Further, the system may be immediately responsive to instructions from a boxing or bagging station manager, a push button request, and/or a human machine interface instruction to immediately consider the container to be completed. When the control system 1002 considers a container to be completed, a bag-complete label is printed as shown at 1022, and a new empty container is requested in a container swap as shown at 1024. The detector pairs on the new empty container may be checked to ensure that the container is empty. The completed container is then discharged as shown at 1026 onto a conveyor (e.g., a bin holding conveyor 32 as shown in FIG. 1). Once a bin is determined to be ready to be discharged (completed), the system moves the completed bin onto the replenishment and takeaway conveyor as discussed above.

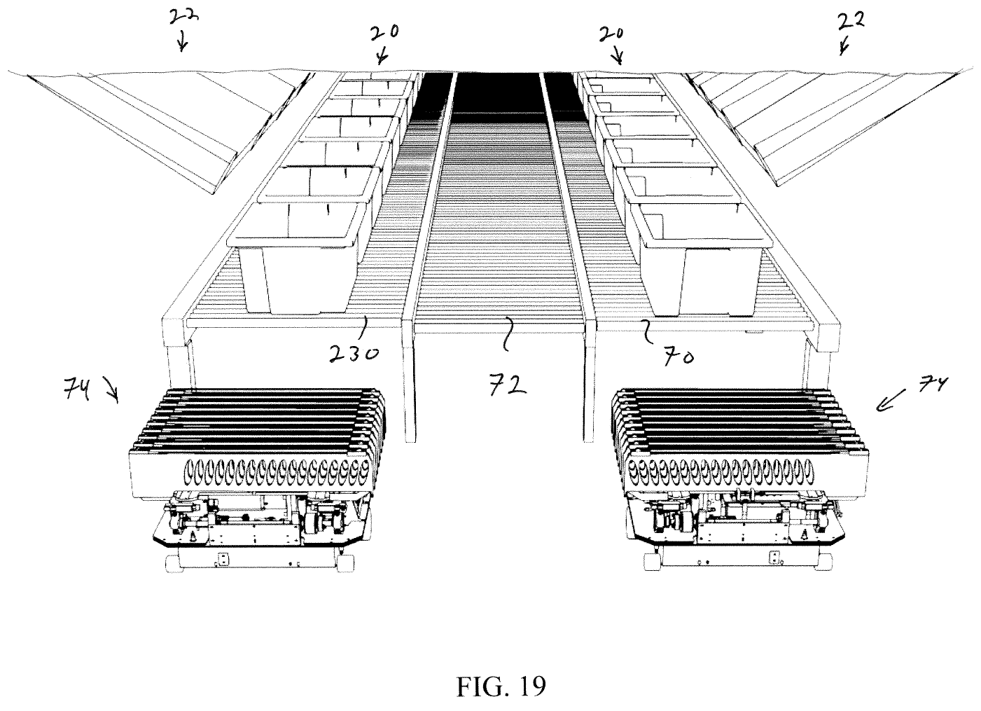

In accordance with further aspects, systems may be provided with parallel output layouts that reduce the number of transfer units or conveyors as discussed above for example with reference to FIG. 6 in which two static shelves shared one replenishment/takeaway conveyor. FIG. 19 shows a system in accordance with an aspect of the present invention that includes two shelves 70, 230 on either side of a replenishment and takeaway conveyor 72. Two transfer units 74 are also used, one of which is provided for reciprocal movement beneath the shelf 70 and the other is provided for reciprocal movement beneath the shelf 230. Each transfer unit may be moved under its respective shelf and actuated to lift and eject a container 20 (under a chute 22) onto the conveyor 72 as discussed above. Such a system may further provide that empty containers are provided to the system via the shelves 70, 230 as conveyors (e.g., at a distal end thereof).

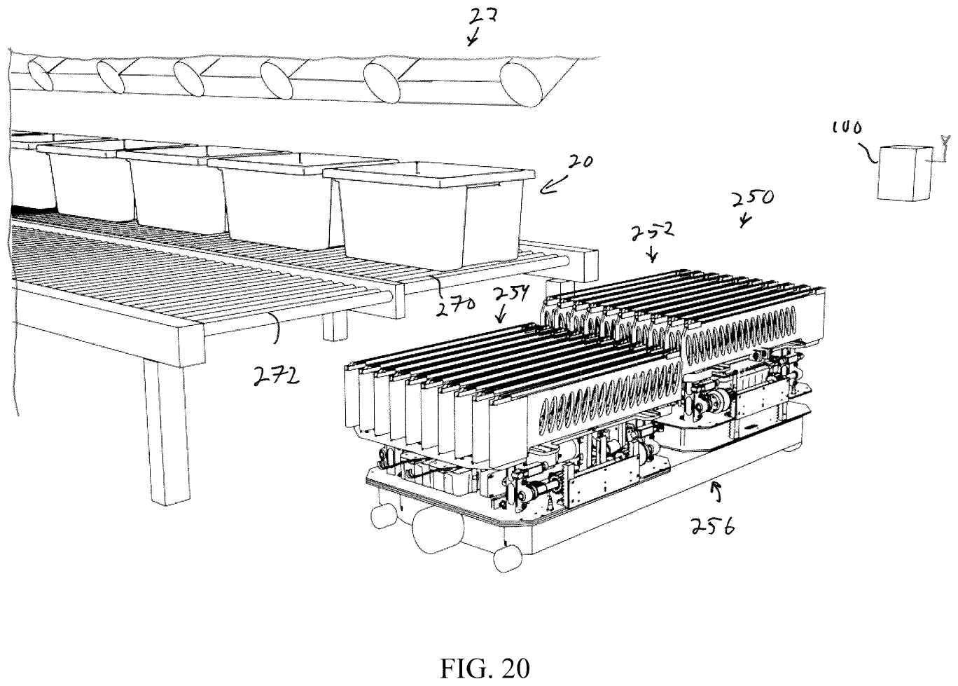

FIG. 20 shows a system in accordance with another aspect of the present invention that includes a shelf 270 and a replenishment and takeaway conveyor 272 with a double width automated mobile transfer unit 250 under both the shelf 70 and the replenishment and takeaway conveyor 272. The transfer unit 250 include two independently movable support structure and payload receiving portions 254, 256 mounted on a common unit base 256. The transfer unit may be moved under the shelf and conveyor, and when a container is to be moved (from either the shelf or the conveyor), the support structure and payload receiving portion 254, 256 under the container to be moved is elevated by the elevation system and transferred by the narrow-belted conveyors thereon as discussed above. In this way a completed container on the shelf 270 may be ejected onto the conveyor 272, and an empty container on the conveyor 270 may be transferred onto the shelf 270.

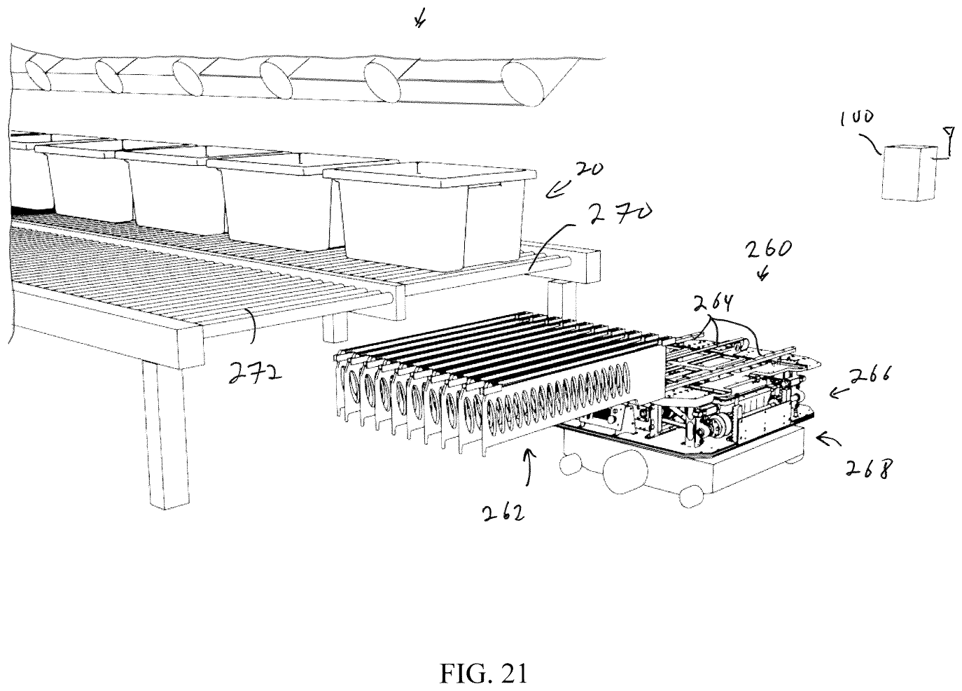

FIG. 21 shows a system in accordance with another aspect of the present invention that includes a shelf 270 and a replenishment and takeaway conveyor 272 with an extendable automated mobile transfer unit 260 under either the shelf 70 or the replenishment and takeaway conveyor 272 (under the shelf 270 is shown). The transfer unit 260 include a movable support structure and payload receiving portion 266 as discussed above mounted on a base 268, but the payload receiving portion is further extendable via tracks 264 in a cantilevered fashion away from the base as shown. The transfer unit may be moved (e.g., under the shelf), and when a container is to be moved (from either the shelf or the conveyor), the payload receiving portion 262 will extend if required to be under the container, and then become elevated by the elevation system and transferred by the narrow-belted conveyors thereon as discussed above. In this way a completed container on the shelf 270 may be ejected onto the conveyor 272, and an empty container on the conveyor 270 may be transferred onto the shelf 270.

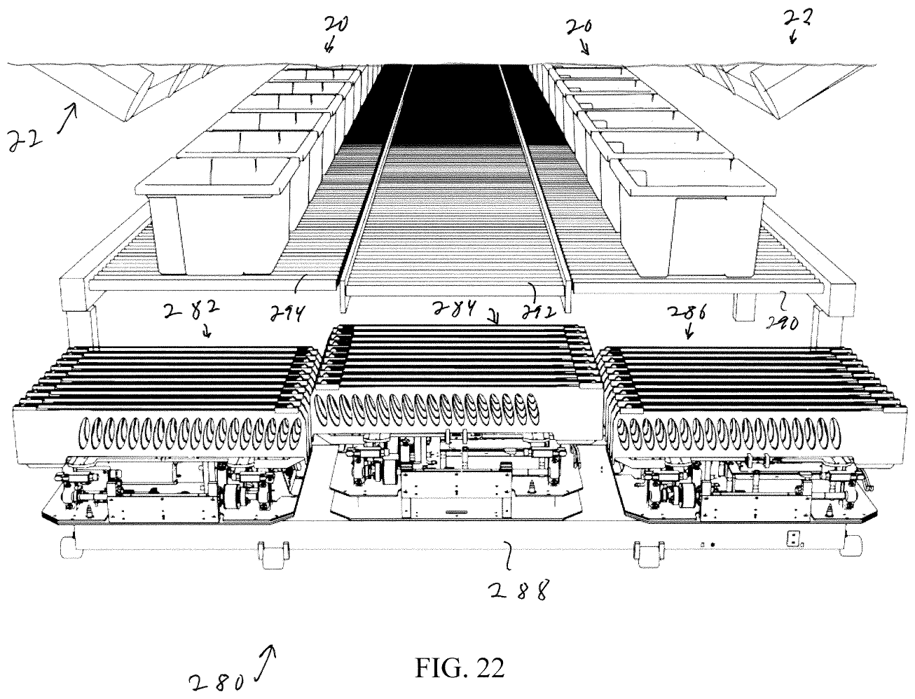

FIG. 22 shows a system in accordance with a further aspect of the present invention that includes two shelves 290, 294 and a replenishment and takeaway conveyor 292 with a triple width automated mobile transfer unit 280 under both the shelves 290, 294 and the replenishment and takeaway conveyor 292. The transfer unit 280 include three independently movable support structure and payload receiving portions 282, 284, 286 mounted on a common unit base 288. The transfer unit may be moved under the shelves and conveyor, and when a container is to be moved (from either shelf or the conveyor), the support structure and payload receiving portion 282, 284, 286 under the container to be moved is elevated by the elevation system and transferred by the narrow-belted conveyors thereon as discussed above. In this way a completed container on either shelf 290, 294 may be ejected onto the conveyor 292, and an empty container on the conveyor 292 may be ejected onto either shelf 290, 294. The belts on the support structure and payload receiving portion 284 may be actuated in either direction.

Those skilled in the art will appreciate that numerous modifications and variations may be made to the above disclosed embodiments without departing from the spirit and scope of the present invention.

What is claimed is:

1. An object processing system comprising:
a first support structure for supporting a plurality of containers that are positioned to receive a plurality of objects among the plurality of containers;
a second support structure for receiving any of the plurality of containers from the first support structure when each of the plurality of containers is ready to be discharged from the first support structure; and
an automated mobile transfer unit for selectively transferring a selected container of the plurality of containers from the first support structure to the second support structure, said automated mobile transfer unit including a mobile chassis unit for moving the at least one automated mobile transfer unit in a first direction among the first support structure and the second support structure, and a payload transfer system supported by the mobile chassis unit and adapted to transfer a selected container of the plurality of containers from the first support structure to the second support structure.

2. The object processing system as claimed in claim 1, wherein the payload transfer system of the automated mobile transfer unit includes a plurality of elevatable belts that may be raised and lowered with respect to the mobile chassis unit, wherein at least one of the plurality if elevatable belts may engage the selected container of the plurality of containers, and wherein each of the elevatable belts may be actuated when elevated to move the selected container thereon off of the automated mobile transfer unit to the second support structure.

3. The object processing system as claimed in claim 1, wherein the first support structure includes a stationary shelving on which the plurality of containers are provided, and wherein each of the elevatable belts of the payload transfer system may be elevated between adjacent tines of the stationary shelving.

4. The object processing system as claimed in claim 3, wherein each of the tines of the stationary shelving is supported at both ends thereof.

5. The object processing system as claimed in claim 3, wherein the object processing system further includes a plurality of chutes each of which leads to a container of the plurality of containers on the stationary shelving.

6. The object processing system as claimed in claim 1, wherein the first support structure includes a roller conveyor system, and wherein each of the elevatable belts of the payload transfer system may be elevated between adjacent rollers of the roller conveyance system.

7. The object processing system as claimed in claim 6, wherein the roller conveyor system is biased to move bins thereon toward one end of the roller conveyor system such that when the selected container is removed from the first support structure the roller conveyor system causes the containers of the plurality of bins to be bought together biased toward the one end of the roller conveyor system, permitting a new empty container to be introduced at a second end of the roller conveyor system opposite the first end.

8. The object processing system as claimed in claim 6, wherein the object processing system further includes a plurality of chutes each of which leads to a container of the plurality of containers on the roller conveyor system.

9. The object processing system as claimed in claim 1, wherein the first support structure is adjacent the second support structure.

10. The object processing system as claimed in claim 1, wherein the second support structure includes a conveyance system that is biased to move any bins thereon in an output direction toward an output end of the conveyance system.

11. An automated mobile transfer unit for use in an object processing system, said automated mobile transfer unit comprising:
a mobile chassis unit for moving the automated mobile transfer unit in a first direction; and
a payload transfer system supported by the mobile chassis unit, wherein the payload transfer system of the automated mobile transfer unit includes a plurality of elevatable belts that may be raised and lowered with respect to the mobile chassis unit such that at least one of the plurality of elevatable belts may engage a selected container on a support structure of the object processing system when raised, and wherein each of the elevatable belts may be actuated when elevated to move the selected container thereon off of the automated mobile transfer unit.

12. The automated mobile transfer unit as claimed in claim 11, wherein the bin support structure includes a stationary shelving on which a plurality of containers are provided.

13. The automated mobile transfer unit as claimed in claim 12, wherein the stationary shelving includes a plurality of tines.

14. The automated mobile transfer unit as claimed in claim 12, wherein each of the tines of the stationary shelving is supported at both ends thereof.

15. The automated mobile transfer unit as claimed in claim 12, wherein the object processing system further includes a plurality of chutes each of which leads to a container of the plurality of containers on the stationary shelving.

16. The automated mobile transfer unit as claimed in claim 11, wherein the container support structure includes a roller conveyor system, and wherein each of the elevatable belts of the payload transfer system may be elevated between adjacent rollers of the roller conveyance system.

17. The automated mobile transfer unit as claimed in claim 16, wherein the roller conveyor system is biased to move bins thereon toward one end of the roller conveyor system such that when the selected bin is removed from the first support structure the roller conveyor system causes the containers of the plurality of bins to be bought together biased toward the one end of the roller conveyor system, permitting a new empty container to be introduced at a second end of the roller conveyor system opposite the first end.

18. The automated mobile transfer unit as claimed in claim 16, wherein the object processing system further includes a plurality of chutes each of which leads to a container of the plurality of containers on the roller conveyor system.

19. The automated mobile transfer unit as claimed in claim 16, wherein the object processing system further includes an output support structure that includes a conveyance system that is biased to move any containers thereon in an output direction toward an output end of the conveyance system.

20. An automated storage and retrieval system that includes the mobile transfer unit of claim 11 such that the mobile transfer unit facilitates storing and retrieving objects.

21. A method of processing objects, said method comprising:
receiving a plurality of objects at a plurality of containers on a first support structure;
moving an automated mobile transfer unit in a first direction, said automated mobile transfer unit including a mobile chassis unit and a payload transfer system on the mobile chassis unit;
stopping the automated mobile transfer unit under a selected container of the plurality of containers;
raising the payload transfer system with respect to the mobile chassis unit to engage the selected container with a portion of the payload transfer system; and
actuating the payload transfer system to move the selected bin away from the first support structure.

22. The method of claim 21, wherein the method further includes determining that the selected container of the plurality of containers is full or otherwise ready to be transferred responsive to a scheduled departure time.

23. The method of claim 21, wherein the method further includes determining that the selected container of the plurality of containers is full or otherwise ready to be transferred responsive to a non-scheduled (changed) departure time.

24. The method of claim 21, wherein the actuating the payload transfer system to move the selected container away from the first support structure includes moving the selected container onto a second support structure.

25. The method of claim 21, wherein the payload transfer system of the automated mobile transfer unit includes a plurality of elevatable belts that may be raised and lowered with respect to the mobile chassis unit, wherein the raising the payload transfer system includes raising each of the elevatable belts to engage the selected container.

26. The method of claim 25, wherein the actuating the payload transfer system includes actuating at least one of the elevatable belts to move the selected container thereon off of the automated mobile transfer unit to the second support structure.

27. The method of claim 25, wherein the first support structure includes a stationary shelving on which the plurality of container are provided, and wherein each of the elevatable belts of the payload transfer system may be elevated between adjacent tines of the stationary shelving.

28. The method of claim 27, wherein each of the tines of the stationary shelving is supported at both ends thereof.

29. The method of claim 21, wherein the first support structure includes a roller conveyor system, and wherein each of the elevatable belts of the payload transfer system may be elevated between adjacent rollers of the roller conveyance system.

30. The method of claim 29, wherein the roller conveyor system is biased to move containers thereon toward one end of the roller conveyor system such that when the selected container is removed from the first support structure the roller conveyor system causes the containers of the plurality of containers to be bought together biased toward the one end of the roller conveyor system, permitting a new empty container to be introduced at a second end of the roller conveyor system opposite the first end.

31. The method of claim 24, wherein the second support structure includes a conveyance system that is biased to move any containers thereon in an output direction toward an output end of the conveyance system.
